(19) United States
(12) Patent Application Publication
(10) Pub. No.: US 2004/0162095 A1
(43) Pub. Date: Aug. 19, 2004

(54) Voice buffering during call setup

(75) Inventors: David Wilson Edwards, Scottsdale, AZ (US); Deepak Ahya, Plantation, FL (US)

Correspondence Address: FLEIT, KAIN, GIBBONS, GUTMAN, BONGINI, & BIANCO P.L., 551 N.W. 77TH STREET, SUITE 111, BOCA RATON, FL, 33487, US

(73) Assignee: MOTOROLA, INC., Schaumburg, IL

(21) Appl. No.: 10/368,185

(22) Filed: Feb. 18, 2003

(51) Int. Cl. H04Q 7/20; H04B 7/00

(52) U.S. Cl. 455/518; 455/521

(57) ABSTRACT

A system, method and computer readable medium for facilitating call setup on a wireless device is disclosed. The method on a push-to-talk wireless device includes receiving a talk request from a user of the wireless device. The method further includes receiving and storing audio in memory. The method further includes initiating a connection setup procedure with a wireless network and receiving a message from the wireless network indicating establishment of a connection. The method further includes transmitting to the wireless network the audio stored in the memory of the wireless device, wherein the step of receiving audio from the user occurs before the step of receiving a message from the wireless network.

### FIELD OF THE INVENTION

The present invention generally relates to the field of wireless communications, and more particularly relates to call setup between wireless devices.

### BACKGROUND OF THE INVENTION

With the advent of pagers and mobile phones the wireless service industry has grown into a multi-billion dollar industry. Recently, push-to-talk wireless devices have grown in popularity. Push-to-talk wireless devices allow two-way analog radio-like communication in which only one user can speak at once and a user pushes a button to commence speaking. Unlike typical two-way analog radios, however, conventional digital push-to-talk wireless devices require a call setup and a talk ready tone. That is, when a user pushes a push-to-talk button, the wireless network proceeds to initiate a call setup and subsequently, upon the successful completion of the setup, the wireless device issues a talk ready tone to indicate to the user that he may begin speaking. The time delay between the moment the user pushes a push-to-talk button and the moment the wireless device issues a talk ready tone is usually between one-half and twenty seconds.

This time delay can be annoying and disconcerting to the user. Further, the time delay is a departure from the well-known two-way analog radio communication protocol in which a user simply pushes the push-to-talk button and can immediately begin speaking. In addition, the talk ready tone can be annoying to bystanders or other situated near the user of the wireless device. Also, the use of a talk ready tone results in a significant delay between the moment the call is setup and the moment the user actually starts speaking as a result of hearing the talk ready tone.

Therefore a need exists to overcome the problems with the prior art as discussed above.

### SUMMARY OF THE INVENTION

Briefly, in accordance with the present invention, disclosed is a system, method and computer readable medium for facilitating call setup on a wireless device. In an embodiment of the present invention, the method on a wireless device includes receiving a talk request from a user of the wireless device. The method further includes receiving and storing audio in a memory. The method further includes initiating a connection setup procedure with a wireless network and receiving a message from the wireless network indicating establishment of a connection. The method further includes transmitting to the wireless network the audio stored in the memory of the wireless device, wherein the step of receiving audio from the user occurs before the step of receiving a message from the wireless network.

In another embodiment of the present invention, a wireless device includes a push-to-talk button for receiving a talk request from a user of the wireless device and a microphone for receiving audio from the user of the wireless device. The wireless device further includes a memory module for storing the audio in the wireless device and a processor for initiating a connection setup procedure with a wireless network. The wireless device further includes a receiver for receiving a message from the wireless network indicating establishment of a connection and a transmitter for transmitting to the wireless network data that initiates setup and the audio stored in the memory of the wireless device.

The preferred embodiments of the present invention are advantageous because of the elimination to the user of the time delay for call setup. Specifically, there is substantially no time delay between the pressing of the push-to-talk button and the moment the wireless device may receive audio from the user. Thus, a user can simply push the push-to-talk button and start speaking. Also, there is no perceivable time delay to the receiver because he is not aware of when the sender's message was actually spoken. This allows for a smoother and more natural communication experience for the users of the wireless devices. In addition, this paradigm conforms to the accepted and widely-used two-way analog radio communication protocol. Also, preferred embodiments set no time limit on the time period between the reception of user audio and the connection setup.

Further, the necessity for a talk ready tone is eliminated. Talk ready tones can be annoying to the user and bystanders. In addition, talk ready tones get in the way of smooth-flowing communication between users of the wireless devices.

Moreover, user audio is stored during call setup with no perceivable degradation in audio quality. Thus the audio, when transmitted after call setup is completed, maintains its audio quality.

### BRIEF DESCRIPTION OF THE DRAWINGS

FIG. 1 is a block diagram illustrating a wireless communication system according to a preferred embodiment of the present invention.

FIG. 2 is a more detailed block diagram of the wireless communication system of FIG. 1.

FIG. 3 is a block diagram illustrating a wireless device according to a preferred embodiment of the present invention.

FIG. 4 is an operational flow diagram for a conventional call setup process of a push-to-talk wireless device with a wireless network.

FIG. 5 is an operational flow diagram of a call setup process of a push-to-talk wireless device with a wireless network according to a preferred embodiment of the present invention.

FIG. 6 is a block diagram illustrating a call setup of a push-to-talk wireless device with a wireless network according to a preferred embodiment of the present invention.

FIG. 7 is a block diagram illustrating a conventional VoIP stack for a VoIP-based dispatch wireless network.

FIG. 8 is an operational flow diagram of a conventional TCP connection process of a push-to-talk wireless device with a wireless network.

FIG. 9 is an operational flow diagram of a conventional SIP connection process of a push-to-talk wireless device with a wireless network.

FIG. 10 is an operational flow diagram of a TCP connection process of a push-to-talk wireless device with a wireless network according to a preferred embodiment of the present invention.

FIG. 11 is an operational flow diagram of an SIP connection process of a push-to-talk wireless device with a wireless network according to a preferred embodiment of the present invention.

### DETAILED DESCRIPTION

The present invention, according to a preferred embodiment, overcomes problems with the prior art by eliminating the call setup delay perceived by users of a push-to-talk wireless device.

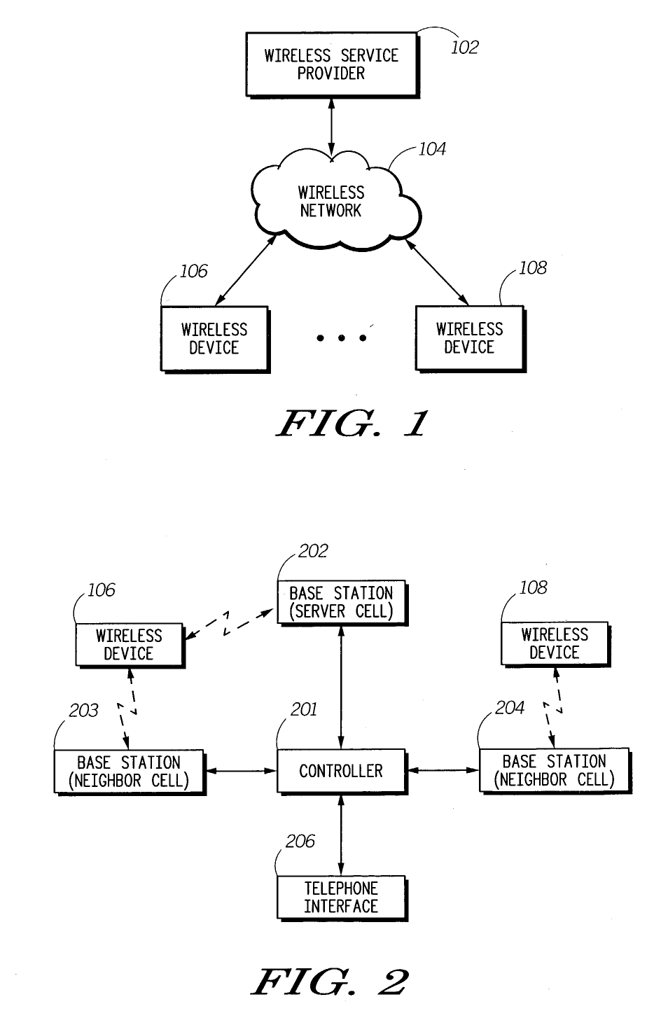

FIG. 1 is a block diagram illustrating a wireless communication system according to a preferred embodiment of the present invention. The exemplary wireless communication system of FIG. 1 includes a wireless service provider 102, a wireless network 104 and wireless devices 106 through 108. The wireless service provider 102 is a first-generation analog mobile phone service, a second-generation digital mobile phone service or a third-generation Internet-capable mobile phone service. The exemplary wireless network 104 is a mobile phone network, a mobile text messaging device network, a pager network, or the like. Further, the communications standard of the wireless network 104 of FIG. 1 is Code Division Multiple Access (CDMA), Time Division Multiple Access (TDMA), Global System for Mobile Communications (GSM), General Packet Radio Service (GPRS), Frequency Division Multiple Access (FDMA) or the like.

The wireless network 104 supports any number of wireless devices 106 through 108, which are mobile phones, push-to-talk mobile radios, text messaging devices, handheld computers, pagers, beepers, or the like.

FIG. 2 is a more detailed block diagram of the wireless communication system of FIG. 1. The wireless communication system of FIG. 2 includes a controller 201 coupled to base stations 202, 203, and 204. In addition, the wireless communication system of FIG. 2 is interfaced to an external network through a telephone interface 206. The base stations 202, 203, and 204 individually support portions of a geographic coverage area containing subscriber units or transceivers (i.e., mobile devices) 106 and 108 (see FIG. 1). The mobile devices 106 and 108 interface with the base stations 202, 203, and 204 using a communication protocol, such as CDMA, FDMA, CDMA, GPRS or GSM.

The geographic coverage area of the wireless communication system of FIG. 2 is divided into regions or cells, which are individually serviced by the base stations 202, 203, and 204 (also referred to herein as cell servers). A mobile device operating within the wireless communication system selects a particular cell server as its primary interface for receive and transmit operations within the system. For example, mobile device 106 has cell server 202 as its primary cell server, and mobile device 108 has cell server 204 as its primary cell server. Preferably, a mobile device selects a cell server that provides the best communication interface into the wireless communication system. Ordinarily, this will depend on the signal quality of communication signals between a mobile device and a particular cell server.

As a mobile device moves between various geographic locations in the coverage area, a hand-off or hand-over may be necessary to another cell server, which will then function as the primary cell server. A mobile device monitors communication signals from base stations servicing neighboring cells to determine the most appropriate new server for hand-off purposes. Besides monitoring the quality of a transmitted signal from a neighboring cell server, the mobile device also monitors the transmitted color code information associated with the transmitted signal to quickly identify which neighbor cell server is the source of the transmitted signal.

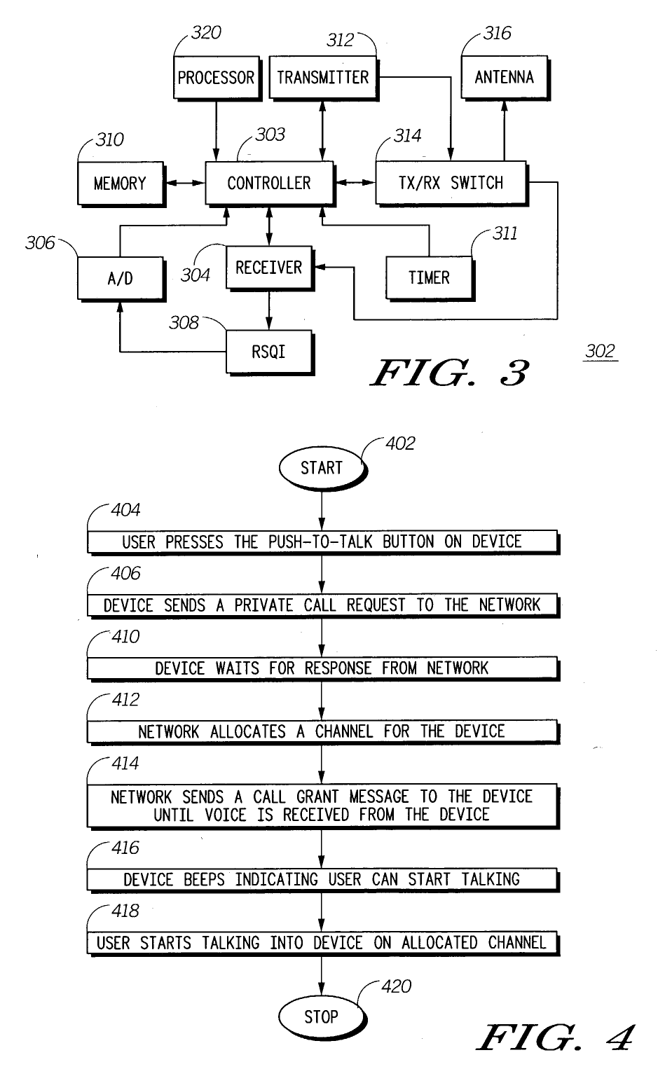

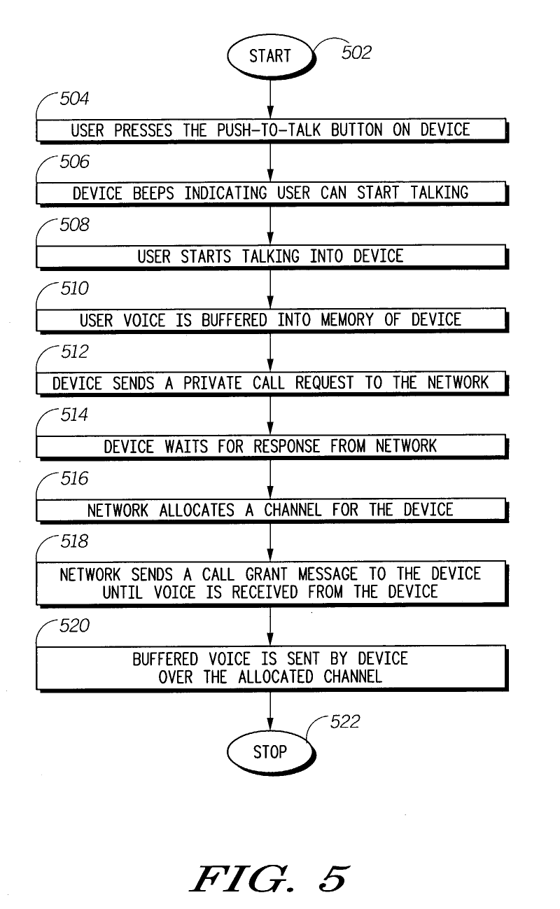

FIG. 3 is a block diagram illustrating a wireless device according to a preferred embodiment of the present invention. FIG. 3 shows a wireless device 302, such as wireless devices 106 through 108 of FIG. 1. In one embodiment of the present invention, the wireless device 302 is a two-way radio capable of receiving and transmitting radio frequency signals over a communication channel under a communications protocol such as CDMA, FDMA, CDMA, GPRS or GSM. The wireless device 302 operates under the control of a controller 303 which switches the wireless device 302 between receive and transmit modes. In receive mode, the controller 303 couples an antenna 316 through a transmit/receive switch 314 to a receiver 304. The receiver 304 decodes the received signals and provides those decoded signals to the controller 303. In transmit mode, the controller 303 couples the antenna 316, through the switch 314, to a transmitter 312.

The controller 303 operates the transmitter and receiver according to instructions stored in memory 310. These instructions include a neighbor cell measurement scheduling algorithm. In preferred embodiments of the present invention, memory 310 is non-volatile memory, Flash memory or Random Access Memory. A timer module 311 provides timing information to the controller 303 to keep track of timed events. Further, the controller 303 can utilize the time information from the timer module 311 to keep track of scheduling for neighbor cell server transmissions and transmitted color code information.

When a neighbor cell measurement is scheduled, the receiver 304, under the control of the controller 303, monitors neighbor cell servers and receives a “received signal quality indicator” (RSQI). RSQI circuit 308 generates RSQI signals representing the signal quality of the signals transmitted by each monitored cell server. Each RSQI signal is converted to digital information by an analog-to-digital converter 306 and provided as input to the controller 303. Using the color code information and the associated received signal quality indicator, the mobile device 302 determines the most appropriate neighbor cell server to use as a primary cell server when hand-off is necessary.

Processor 320 in FIG. 3 performs various functions such as the functions attributed to call setup procedures, as described below with reference to FIGS. 5, 10 and 11. In various embodiments of the present invention, the processor 320 in FIG. 3 is a single processor or more than one processor for performing the tasks described below.

FIG. 4 is an operational flow diagram showing a conventional call setup process of a push-to-talk wireless device with a wireless network. The operational flow diagram of FIG. 4 depicts the conventional process of setting up a call (i.e., call setup) for a push-to-talk wireless device 302 on a wireless network 104. The operational flow diagram of FIG. 4 begins with step 402 and flows directly to step 404.

In step 404, the user of the wireless device 302 presses the push-to-talk button. This indicates to the wireless device 302 that the user is ready to begin transmitting audio. Then, the wireless device 302, in step 406, sends a call request to the wireless network 104. The wireless network 104 proceeds to attempt to set up a call between the wireless device 302 and the intended recipient of the call. In the interim, the user and the wireless device 302, in step 410, wait for a call grant message from the wireless network 104.

The wireless network 104, in step 412, proceeds to complete a connection with the intended recipient of the call and subsequently allocates a channel for communication for the wireless device 302. Next, the wireless network 104, in step 414, sends a call grant message to the wireless device 302. The call grant message is a message indicating to the wireless device 302 that a connection with the intended recipient of the call has been made and that a channel for communication has been allocated. The wireless network 104 continues to send a call grant message to the wireless device 302 until transmitted audio is received from the wireless device 302.

In response to receiving the call grant message from the wireless network 104, the wireless device 302, in step 416, indicates to the user that the wireless device is ready to begin receiving audio for transmission. In one embodiment, the wireless device 302 indicates this by generating a beep or other representative tone. Subsequently, the user begins sending audio (by speaking into the wireless device 302, for example) via the wireless device 302, in step 418, over the channel allocated by the wireless network 104. The operational flow diagram of FIG. 4 ceases in step 420.

It should be noted that there is a delay between step 404 and step 416. That is, there is a delay between the time the user presses the push-to-talk button and the time the wireless device 302 beeps to indicate that it is ready to begin transmitting audio. This can be disconcerting and annoying to a user. In addition, it is a departure from the well known operation of a two-way radio in which a user simply pushes a push-to-talk button and immediately begins speaking into the radio.

FIG. 5 is an operational flow diagram showing a call setup process of a push-to-talk wireless device with a wireless network according to a preferred embodiment of the present invention. The operational flow diagram of FIG. 5 depicts the process of setting up a call (i.e., call setup) for a push-to-talk wireless device 302 on a wireless network 104 according to one embodiment of the present invention. The operational flow diagram of FIG. 5 begins with step 502 and flows directly to step 504.

In step 504, the user of the wireless device 302 presses the push-to-talk button. This indicates to the wireless device 302 that the user is ready to begin transmitting audio. In response to detecting the pressing of the push-to-talk button, the wireless device 302, in optional step 506, indicates to the user that the wireless device is ready to begin receiving audio for transmission. In one embodiment, the wireless device 302 indicates this by generating a beep or other representative tone. In another embodiment, optional step 506 occurs only after the user has released the push-to-talk button. In yet another embodiment, the beep or other tone of optional step 506 is not provided or can be turned off by the user.

Subsequently, the user begins providing audio (by speaking into the wireless device 302, for example) to the wireless device 302, in step 508. The wireless device 302, in step 510, proceeds to receive and store (i.e., buffer) the audio provided by the user in step 508 in memory 310 (see FIG. 3) of wireless device 302. Typically, a first communication over a two-way push-to-talk radio is short. For example, first communications are often of a type that request simple acknowledgement, such as “Do you Copy?” or “Can you read me?” This allows for quick and easy reception and storage of the first communication. The process of receiving and storing the first communication is described in greater detail below.

Then, the wireless device 302, in step 512, sends a call request to the wireless network 104. The wireless network 104 proceeds to attempt to set up a call between the wireless device 302 and the intended recipient of the call. In the interim, the wireless device 302, in step 514, waits for a call grant message from the wireless network 104.

The wireless network 104, in step 516, proceeds to complete a connection with the intended recipient of the call and subsequently allocates a channel for communication for the wireless device 302. Next, the wireless network 104, in step 518, sends a call grant message to the wireless device 302. The call grant message is a message indicating to the wireless device 302 that a connection with the intended recipient of the call has been made and that a channel for communication has been allocated. Preferably, the wireless network 104 continues to send a call grant message to the wireless device 302 until transmitted audio is received from the wireless device 302.

In response to receiving the call grant message from the wireless network 104, the wireless device 302, in step 520, proceeds to send the stored (or buffered) audio. The wireless device sends to the intended recipient of the call the buffered audio and then proceeds to transmit unbuffered audio in real-time. Subsequently, the user sends audio (by speaking into the wireless device 302, for example) via the wireless device 302 over the channel allocated by the wireless network 104. The operational flow diagram of FIG. 5 ceases in step 522.

It should be noted that there is no perceivable delay between step 504 and step 506. That is, there is no perceivable delay between the time the user presses the push-to-talk button and the time the wireless device 302 beeps to indicate that it is ready to begin transmitting audio. This allows for conformity with the known use of a two-way radio in which a user simply pushes a push-to-talk button and immediately begins speaking into the radio. In addition, it allows for easier and more natural communication between wireless device users.

In the event that the wireless network 104 does not allocate a channel for wireless device 302 because the call setup procedure was not successful (for example, due to the unavailability of RF channels or the unavailability of the receiving wireless device), then in an alternative step 518, the wireless network 104 notifies the wireless device 302 and the wireless device 302 notifies the user that the call setup has failed. In one preferred embodiment, the wireless device 302 asks the user if he wishes to save the audio that was stored in step 510 and automatically retry delivery of the audio when the receiving wireless device becomes available. In another preferred embodiment, voice announcements are provided to the wireless device 302 indicating the status of the call setup procedure.

It should be noted that the timing of steps 508 and 510 may vary from that illustrated. That is, steps 508 and 510 may occur any time between step 506 and step 520. The timing of steps 508 and 510 depends on when the use actually begins talking (or providing audio). For example, the wireless device 302 may perform steps 512 and 514 before the user begins to talk. Similarly, other alternative sequences for the illustrated steps are possible in further embodiments of the present invention. For example, the wireless device may perform step 512 before step 506. Regardless, the wireless device 302 is prepared to accept audio (i.e., speech form the user) before step 518.

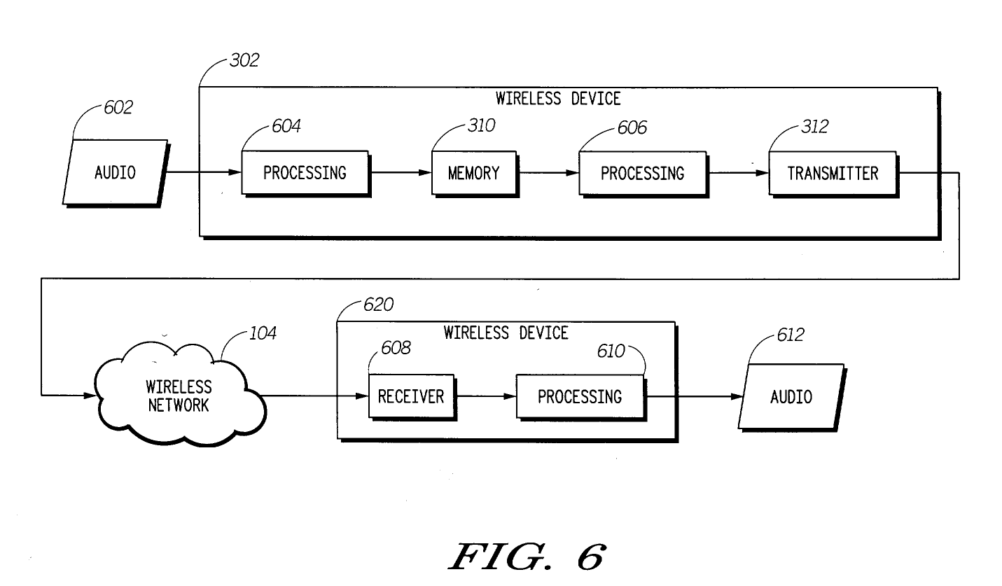

FIG. 6 is a block diagram illustrating a call setup of a push-to-talk wireless device with a wireless network according to a preferred embodiment of the present invention. FIG. 6 shows the wireless network 104 of FIG. 1. Also shown is the relevant portion of the wireless device 302, as described in greater detail in FIG. 3, and a companion wireless device 620, of the same type as wireless device 302. FIG. 6 depicts the progression of audio data from the initiating wireless device 302 to a receiving wireless device 602 during a call setup process, as described in FIG. 5.

FIG. 6 shows that audio 602, such as speech, is introduced into the wireless device 302, typically through a microphone (as in step 508 of FIG. 5). Next, the wireless device 302 subjects to the audio 602 to processing 604 including, for example, analog-to-digital conversion, noise filtering and encoding. Then the wireless device 302 proceeds to store (i.e., buffer) the processed audio 602 in the memory 310 (see FIG. 3) of wireless device 302 (as in step 510). As explained above, memory 310 can be Flash memory or Random Access Memory. Upon the reception of a call grant message from the wireless network 104 (as in step 518), the wireless device 302 retrieves the audio 602 stored in memory 310 and processes 606 it for transmission, including, for example, forward error correction. The transmitter 312 of wireless device 312 proceeds to transmit the processed audio.

Next, the wireless network 104 receives the transmitted audio and proceeds to forward it to the intended recipient (i.e., wireless device 620). The receiver 608 (analogous to receiver 304 of FIG. 3) of wireless device 620 receives the transmitted audio 602 and proceeds to process 610 it, including, for example, error correction, noise filtering, demodulation, Viterbi decoding and voice decoding. The processed audio 612 is then emitted from the wireless device 620, typically using a speaker.

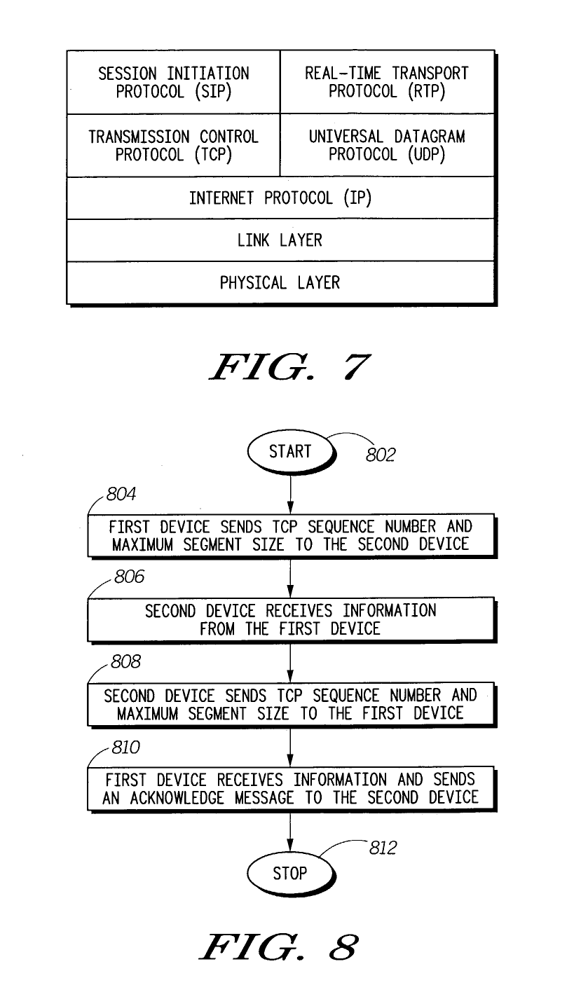

FIG. 7 is a block diagram illustrating a conventional VoIP stack for a VoIP-based dispatch wireless network. In such a network, the wireless service provider 102 exchanges information and instructions with the wireless device 302 using a data packet-based data exchange protocol, such as Transmission Control Protocol over Internet Protocol (TCP/IP) or Universal Datagram Protocol (UDP) over IP. The IP protocol operates over a link layer that regulates connections between entities. The link layer in turn operates over a physical layer.

TCP/IP is used as the transport layer for the IP network layer and Session Initiation Protocol (SIP) is used as the session layer for setting up calls and initiating sessions between wireless devices 302. SIP is an industry standard for communications between mobile devices. Alternatively, UDP is used as the network, transport and session layer for the IP network layer and Real Time Protocol (RTP) is used as the transport layer for exchanging information between wireless devices 302.

FIG. 8 is an operational flow diagram showing a conventional TCP connection process of a push-to-talk wireless device over a wireless network. The operational flow diagram of FIG. 8 depicts the process of setting up a call (i.e., call setup) using a TCP connection (e.g., an established socket) on a wireless network 104. The operational flow diagram of FIG. 8 begins with step 802 and flows directly to step 804.

A first wireless device 302, in step 804, transmits a TCP sequence number (for identifying the current session) and a maximum segment size (for data packet-based data exchange) to a second wireless device, such as wireless device 620 (see FIG. 6). The second wireless device 620, in step 806, receives the information from the first wireless device 302. Then, the second wireless device 620, in step 808, transmits a TCP sequence number and a maximum segment size to the first wireless device 302.

The first wireless device 302, in step 810, receives the information from the second wireless device 620 and proceeds to send an “acknowledge” message to the second wireless device 620 indicating an acknowledgement of the exchange of TCP sequence and maximum segment size information. In step 810, a socket has been established between the two wireless devices. The operational flow diagram of FIG. 8 ceases in step 812.

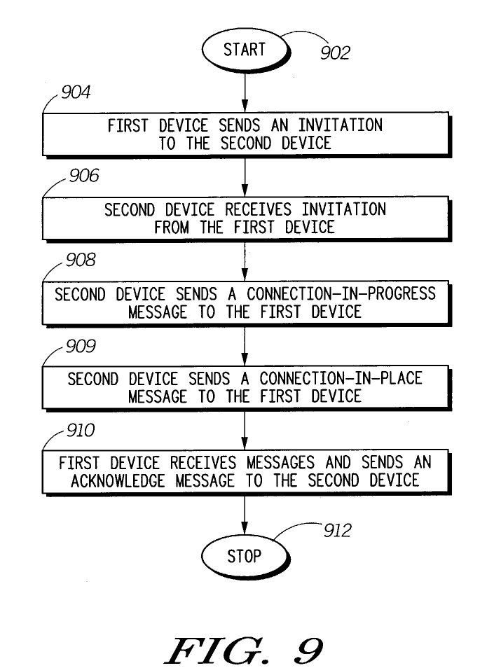

FIG. 9 is an operational flow diagram showing a conventional SIP connection process of a push-to-talk wireless device with a wireless network. The operational flow diagram of FIG. 9 depicts the process of setting up a call (i.e., call setup) using an SIP connection on a wireless network 104. The operational flow diagram of FIG. 9 begins with step 902 and flows directly to step 904.

A first wireless device 302, in step 904, transmits an invitation to a second wireless device, such as wireless device 620 (see FIG. 6). The second wireless device 620, in step 906, receives the invitation from the first wireless device 302. Then, the second wireless device 620, in step 908, transmits a connection-in-progress message to the first wireless device 302, indicating that the establishment of a connection is in progress. Upon establishment of a connection, the second wireless device 620, in step 909, transmits a connection-in-place message to the first wireless device 302, indicating that the establishment of a connection has been completed.

The first wireless device 302, in step 910, receives the connection-in-place message from the second wireless device 620 and proceeds to send an “acknowledge” message to the second wireless device 620 indicating an acknowledgement of acceptance of its invitation. The operational flow diagram of FIG. 9 ceases in step 912.

In an embodiment of the present invention, the SIP connection described in FIG. 9 is established over TCP. In this embodiment, the operational flow diagram of FIG. 9 is preceded by the TCP connection steps described in FIG. 8. In another embodiment of the present invention, the SIP connection described in FIG. 9 is established over UDP. In this embodiment, the operational flow diagram of FIG. 9 is preceded by the standard UDP connection steps.

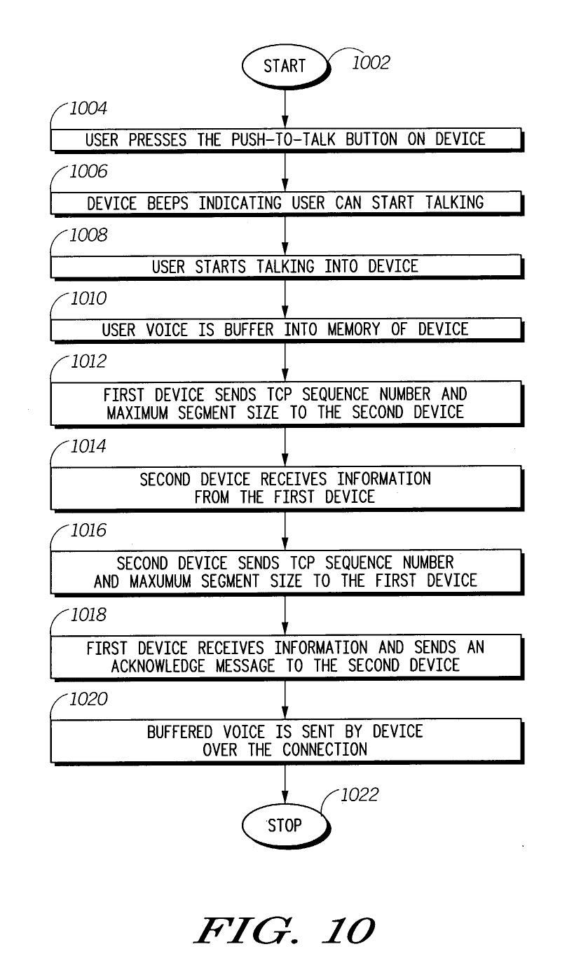

FIG. 10 is an operational flow diagram showing a TCP connection process of a push-to-talk wireless device with a wireless network 104 according to a preferred embodiment of the present invention. The operational flow diagram of FIG. 10 depicts the process of setting up a call (i.e., call setup) for a push-to-talk wireless device 302 using a TCP connection (e.g., an established socket) on a wireless network 104 according to the present invention. The operational flow diagram of FIG. 10 begins with step 1002 and flows directly to step 1004.

In step 1004, the user of the wireless device 302 presses the push-to-talk button. This indicates to the wireless device 302 that the user is ready to begin transmitting audio. In response to detecting the pressing of the push-to-talk button, the wireless device 302, in optional step 1006, indicates to the user that the wireless device is ready to begin receiving audio for transmission. In one embodiment, the wireless device 302 indicates this by generating a beep or other representative tone. Subsequently, the user begins providing audio (by speaking into the wireless device 302, for example) to the wireless device 302, in step 1008.

The wireless device 302, in step 1010, proceeds to receive and store (i.e., buffer) the audio provided by the user in step 1008 in memory 310 (see FIG. 3) of wireless device 302.

The first wireless device 302, in step 1012, transmits a TCP sequence number (for identifying the current session) and a maximum segment size (for data packet-based data exchange) to a second wireless device, such as wireless device 620 (see FIG. 6). The second wireless device 620, in step 1014, receives the information from the first wireless device 302. Then, the second wireless device 620, in step 1016, transmits a TCP sequence number and a maximum segment size to the first wireless device 302.

The first wireless device 302, in step 1018, receives the information from the second wireless device 620 and proceeds to send an “acknowledge” message to the second wireless device 620 indicating an acknowledgement of the exchange of TCP sequence and maximum segment size information. In step 1018, a socket has been established between the two wireless devices.

Subsequent to step 1018, the wireless device 302, in step 1020, proceeds to send the stored audio. In this step, the wireless device sends to the recipient of the call the buffered audio and then proceeds to transmit unbuffered audio in real-time. Subsequently, the user sends audio (by speaking into the wireless device 302, for example) via the wireless device 302 over the established TCP connection. The operational flow diagram of FIG. 10 ceases in step 1022.

In the event that the wireless network 104 does not complete the TCP connection for wireless device 302 because the call setup procedure was not successful (for example, due to the unavailability of RF channels or the unavailability of the receiving wireless device), then in an alternative step 1018, the wireless network 104 notifies the wireless device 302 and the wireless device 302 notifies the user that the call setup has failed. Preferably, the wireless device 302 asks the user if he wishes to save the audio that was stored in step 1010 and automatically retry delivery of the audio when the receiving wireless device becomes available.

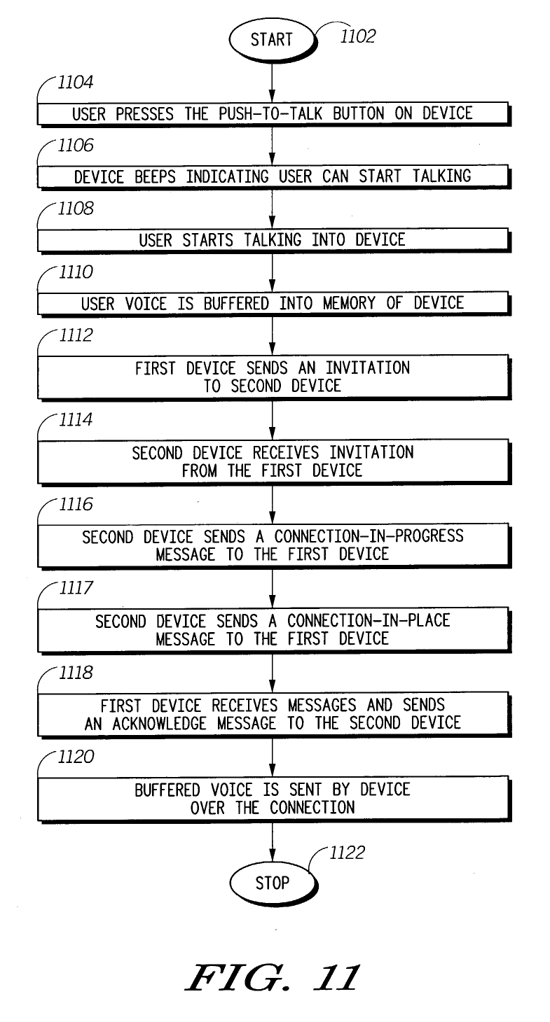

FIG. 11 is an operational flow diagram showing an SIP connection process of a push-to-talk wireless device with a wireless network 104 according to a preferred embodiment of the present invention. The operational flow diagram of FIG. 11 depicts the process of setting up a call (i.e., call setup) for a push-to-talk wireless device 302 using an SIP connection on a wireless network 104 according to the present invention. The operational flow diagram of FIG. 11 begins with step 1102 and flows directly to step 1104.

In step 1104, the user of the wireless device 302 presses the push-to-talk button. This indicates to the wireless device 302 that the user is ready to begin transmitting audio. In response to detecting the pressing of the push-to-talk button, the wireless device 302, in optional step 1106, indicates to the user that the wireless device is ready to begin receiving audio for transmission. In one embodiment, the wireless device 302 indicates this by generating a beep or other representative tone. Subsequently, the user begins providing audio (by speaking into the wireless device 302, for example) to the wireless device 302, in step 1108.

The wireless device 302, in step 1110, proceeds to receive and store (i.e., buffer) the audio provided by the user in step 1108 in memory 310 (see FIG. 3) of wireless device 302.

The first wireless device 302, in step 1112, transmits an invitation to a second wireless device, such as wireless device 620 (see FIG. 6). The second wireless device 620, in step 1114, receives the invitation from the first wireless device 302. Then, the second wireless device 620, in step 1116, transmits a connection-in-progress message to the first wireless device 302, indicating that the establishment of a connection is in progress. Upon establishment of a connection, the second wireless device 620, in step 1117, transmits a connection-in-place message to the first wireless device 302, indicating that the establishment of a connection has been completed.

The first wireless device 302, in step 1118, receives the connection-in-place message from the second wireless device 620 and proceeds to send an “acknowledge” message to the second wireless device 620 indicating an acknowledgement of acceptance of its invitation. Subsequent to step 1118, the wireless device 302, in step 1120, proceeds to send the stored audio. In this step, the wireless device sends to the recipient of the call the buffered audio and then proceeds to transmit unbuffered audio in real-time. Subsequently, the user sends audio (by speaking into the wireless device 302, for example) via the wireless device 302 over the established SIP connection. The operational flow diagram of FIG. 11 ceases in step 1122.

In the event that the wireless network 104 does not complete the SIP connection for wireless device 302 because the call setup procedure was not successful (for example, due to the unavailability of RF channels or the unavailability of the receiving wireless device), then in an alternative step 1118, the wireless network 104 notifies the wireless device 302 and the wireless device 302 notifies the user that the call setup has failed. Preferably, the wireless device 302 asks the user if he wishes to save the audio that was stored in step 1110 and automatically retry delivery of the audio when the receiving wireless device becomes available.

In another embodiment of the present invention, the SIP connection described in FIG. 11 is established over TCP. In this embodiment, the operational flow diagram of FIG. 11 includes the TCP connection steps described in FIG. 8. In yet another embodiment of the present invention, the SIP connection described in FIG. 11 is established over UDP. In this embodiment, the operational flow diagram of FIG. 11 includes the standard UDP connection steps.

While the necessity for a talk ready tone is eliminated by the present invention, in one embodiment the user has the option of keeping the talk ready tone. This is convenient for users who prefer or are used to having the talk ready tone. The talk ready tone can be provided either after the call setup process is complete or at an earlier point in the process.

The present invention can be realized in hardware, software, or a combination of hardware and software in the wireless device. A system according to a preferred embodiment of the present invention can be realized in a centralized fashion in one computer system (of the wireless device), or in a distributed fashion where different elements are spread across several interconnected computer systems. Any kind of computer system—or other apparatus adapted for carrying out the methods described herein—is suited. A typical combination of hardware and software could be a general purpose processor with a computer program that, when being loaded and executed, controls the processor such that it carries out the methods described herein.

The present invention can also be embedded in a computer program product (e.g., in the wireless device), which comprises all the features enabling the implementation of the methods described herein, and which—when loaded in a system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for facilitating call setup on a wireless device, comprising the steps of:
receiving a talk request from a user of the wireless device;
receiving audio from the user of the wireless device;
storing the audio in a memory;
initiating a connection setup procedure with a wireless network;
receiving a message from the wireless network indicating establishment of a connection; and
transmitting to the wireless network the audio stored in the memory,
wherein the step of receiving audio from the user occurs before the step of receiving a message from the wireless network.

2. The method of claim 1, wherein the request includes pushing a push-to-talk button.

3. The method of claim 1, wherein the memory of the wireless device is one of Flash memory and Random Access Memory.

4. The method of claim 1, wherein the step of initiating a connection setup procedure includes the sub-step of sending a call request to the wireless network.

5. The method of claim 1, wherein the step of initiating a connection setup procedure includes the sub-step of setting up a TCP connection between the wireless device and the wireless network.

6. The method of claim 1, wherein the step of initiating a connection setup procedure includes the sub-step of setting up an SIP connection between the wireless device and the wireless network.

7. The method of claim 1, wherein the wireless network is a Voice over Internet Protocol-based dispatch communication system.

8. The method of claim 1, further comprising the step of:
before the step of receiving a message from the wireless network, generating a signal to indicate to the user that the wireless device is ready to receive audio.

9. A method for facilitating call setup on a wireless device, comprising the steps of:
receiving a talk request from a user of the wireless device;
receiving audio from the user of the wireless device;
storing the audio in a memory;
initiating a connection setup procedure with another wireless device through a wireless network;
if a connection with the other wireless device is established, receiving a message from the wireless network indicating establishment of a connection and transmitting to the wireless network the audio stored in the memory; and
if a connection with the other wireless device is not established, receiving a message from the wireless network indicating that a connection was not established.

10. The method of claim 9, wherein the talk request includes pushing a push-to-talk button.

11. The method of claim 9, wherein the step of receiving audio from the user occurs before the step of receiving a message from the wireless network.

12. The method of claim 9, wherein the message received from the wireless network indicating that a connection was not established is a voice announcement of the status of the connection.

13. The method of claim 9, further comprising the step of:
before the step of receiving a message from the wireless network, generating a signal to indicate to the user that the wireless device is ready to receive audio.

14. A push-to-talk wireless device for facilitating call setup, comprising:
a push-to-talk button for receiving a talk request from a user of the wireless device;
a microphone for receiving audio from the user of the wireless device;
a memory module for storing the audio;
a controller for initiating a connection setup procedure with a wireless network;
a receiver for receiving a message from the wireless network indicating establishment of a connection; and
a transmitter for transmitting to the wireless network data that initiates setup and the audio stored in the memory after the receiver receives the message from the wireless network.

15. The push-to-talk wireless device of claim 14, wherein the memory module of the wireless device is one Flash memory and Random Access Memory.

16. The push-to-talk wireless device of claim 14, further comprising:
a speaker for generating a signal indicating that the wireless device is ready to transmit.

17. The push-to-talk wireless device of claim 14, wherein the wireless device operates on a Voice over Internet Protocol-based dispatch communication system.
